(19) United States
(12) Patent Application Publication
(10) Pub. No.: US 2015/0205519 A1
(43) Pub. Date: Jul. 23, 2015

(54) SYSTEM AND METHOD FOR CONVERTING BETWEEN AVN SYSTEM MODES

(71) Applicant: Hyundai Motor Company, Seoul (KR)

(72) Inventor: Yeon Ji Kim, Seoul (KR)

(21) Appl. No.: 14/548,837

(22) Filed: Nov. 20, 2014

(30) Foreign Application Priority Data
Jan. 23, 2014 (KR) 10-2014-0008332

(51) Int. Cl. G06F 3/0488; G06F 3/0486; G06F 3/041

(52) U.S. Cl. CPC G06F 3/04883; G06F 3/0416; G06F 3/0486

(57) ABSTRACT

A system and a method are provided for converting a screen between the AVN modes and detecting an operation of an AVN=being used regardless of an AVN mode currently being displayed. The system includes a controller that is configured to display an AVN mode which is being operated and detect an input signal through a touch unit. A proximity sensor is configured to detect an approach of the touch unit toward the display unit. In addition, the controller is configured to display a home widget on the display unit based on information transmitted from the proximity sensor and distinguish the selected AVN mode based on the input signal to display the AVN mode on the display unit.

### CROSS-REFERENCE TO RELATED APPLICATION

This application claims under 35 U.S.C. §119(a) the benefit of Korean Patent Application No. 10-2014-0008332 filed on Jan. 23, 2014, the entire contents of which are incorporated herein by reference.

### BACKGROUND

(a) Technical Field

The present disclosure relates to a system and a method for converting between audio-video-navigation (AVN) system modes and more particularly, to a system and a method for converting an AVN mode which more easily convert a screen between AVN modes and detect an operation of an AVN in use regardless of an AVN mode currently being displayed.

(b) Background Art

An audio video navigation (AVN) system is a single system in which an audio, a multimedia device, and a navigation device within a vehicle are combined and in other words, a multimedia system and a navigation system which are independently provided in the related art are combined as a single system. Such an AVN system includes a display unit configured to display an operation of the AVN which is being driven, inside the vehicle and a driver may obtain required information on the AVN through the display unit.

The AVN system provides various services through devices such as an audio, a video, and a navigation and operates the AVN mode to provide the services (e.g., switches between the AVN modes). In particular, an AVN mode which is being driven (e.g., operated) is displayed on the AVN display unit. Accordingly, to convert the screen between the AVN modes, a back button disposed within the vehicle is manipulated to perform a process of converting the screen into a previous screen one or more times or alternatively, a home button is manipulated to enter a home mode and a desired AVN mode is performed.

When entering the home mode, a menu that indicates available AVNs in the AVN system is displayed on the screen of the display unit and a desired AVN mode may be selected to be in a standby mode by pressing a move button from the displayed menu one or more times and then a start button is pressed to enter the AVN mode in a standby mode. According to such a mode converting method, when a manipulating process which performs the desired AVN mode is complex, for example, the back button is pressed several times to convert the mode into a desired mode or the home button is pressed to move the home mode and then the move button or the start button is pressed to convert the mode to the desired mode, the driver is required to repeatedly watch the corresponding button or until the driver distinguishes a position of the corresponding button and presses the button to operate the system causing the driver to be distracted from driving, which may cause an accident. Therefore, a technology which simplifies the mode converting process is required.

The above information disclosed in this section is merely for enhancement of understanding of the background of the invention and therefore it may contain information that does not form the prior art that is already known in this country to a person of ordinary skill in the art.

### SUMMARY

The present invention provides a system and a method for converting between AVN system modes which may detect an operation of another AVN mode in a driving AVN mode and may more easily convert a screen between the AVN modes and return to a home mode.

In one aspect, the present invention provides an AVN mode converting system, that may include: a display unit configured to display an AVN mode which is being operated and detect a signal input by touch of a user through a touch unit; a proximity sensor configured to detect the touch unit of the user which approaches the display unit; and a controller configured to display a home widget on the display unit based on information provided from the proximity sensor and distinguish the AVN mode selected by the user based on the signal provided from the display unit to display the AVN mode on the display unit. In addition, the controller may be configured to operate the display unit.

In an exemplary embodiment, the controller may be configured to distinguish the AVN mode which is selected by the user based on a predetermined gesture input to the display unit to display the AVN mode on the display unit. Further, the controller may be configured to distinguish the AVN mode which is selected by the user based on a drag direction of a flicking gesture input to the display unit to display the AVN mode on the display unit. For example, when a flicking gesture which drags a finger in a predetermined direction is input to the display unit while displaying AVN modes other than a home mode on the display unit, the controller may be configured to convert the screen of the display unit into the home mode.

Furthermore, when the touch unit of the user (e.g., a finger, a pen, or the like) approaches the display unit within a predetermined distance or less, the controller may be configured to display the home widget on the display unit to be inoperable to detect only a mode situation. When the touch unit of the user maintains a proximate status to the display unit for a predetermined time or greater within a predetermined distance, the controller may be configured to display the home widget on the display unit to be operable. In addition, when the touch unit of the user is remote from the display unit by a predetermined distance or greater while the home widget is displayed on the display unit to be operable, the controller may be configured to display the home widget on the display unit to be inoperable to detect only a mode situation.

When the touch unit of the user is remote from the display unit by a predetermined distance or greater while the home widget is displayed on the display unit to be inoperable to detect only a mode situation, the controller may be configured to remove the home widget from the display unit. When the touch unit of the user is not operated on the display unit for a predetermined time or greater while the home widget is displayed on the display unit to be operable, the controller may be configured to display the home widget to be inoperable to detect only a mode situation.

Moreover, when the touch unit of the user is not operated on the display unit for a predetermined time or greater while the home widget is displayed on the display unit to be inoperable to detect only a mode situation, the controller may be configured to remove the home widget from the display unit. When any one mode block among menus of the home widget is touched and selected, the controller may be configured to convert the screen of the display unit into an AVN mode that corresponds to the selected mode block. The menu of the home widget may be configured by a plurality of mode blocks that indicates different AVN modes and each mode block may display information regarding an operation of the AVN mode.

In another aspect, the present invention provides an AVN mode converting method that may include: distinguishing a selected AVN mode based on a predetermined gesture input on a display unit which displays any one of the operating AVN modes; and displaying the distinguished AVN mode on the display unit. The AVN mode converting method may further include: displaying a home widget on the display unit based on a detection result of a touch unit of the user which approaches the display unit.

According to the system and the method for converting an AVN mode, a screen between the AVN modes including a home mode may be more easily converted and situation information regarding the operation AVN may be detected in all AVN modes to increase convenience and usability of a user.

### BRIEF DESCRIPTION OF THE DRAWINGS

The above and other features of the present invention will now be described in detail with reference to exemplary embodiments thereof illustrated by the accompanying drawings which are given hereinbelow by way of illustration only, and thus are not limitative of the present invention, and wherein:

FIG. 1 is an exemplary block diagram illustrating an AVN mode converting system according to an exemplary embodiment of the present invention;

FIGS. 2 and 3 are exemplary views illustrating an AVN mode converting method according to an exemplary embodiment of the present invention; and

FIG. 4 is an exemplary view illustrating a method for using a home widget in an AVN mode converting system according to an exemplary embodiment of the present invention.

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

Hereinafter reference will now be made in detail to various exemplary embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the accompanying claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

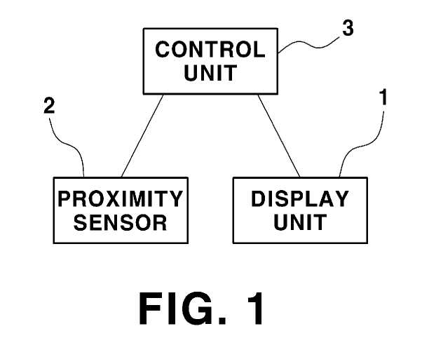

Hereinafter, the present invention will be described so as to be easily carried out by those skilled in the art. As illustrated in FIG. 1, an AVN mode converting system according to an exemplary embodiment of the present invention may include a display unit 1, a proximity sensor 2, and a controller 3 which may be electrically connected to each other to exchange signals. The controller 3 may be configured to operate the display unit 1 and the proximity sensor 2.

The display unit 1 may be a display device disposed within a vehicle and may be configured to provide information regarding various AVNs to be detected by a user and display an AVN mode which is being operated on a screen. In addition, the display unit 1 may be configured to detect a signal input by a user touch through a touch unit. For example, the display unit 1 may be a display device that uses a touch screen and may be configured to detect a touch signal and a gesture signal input onto the screen to transmit the signals to the controller. In particular, a finger of the user or a substitute object (e.g., a touch pen) for which may substitute the finger may be used as the touch unit.

The proximity sensor 2 may be configured to detect the touch unit (e.g., the touching object, the object, etc.) of the user when the object is approaching the display unit 1 and may be mounted within the display 1 or between the display unit 1 and a body of the vehicle to detect the object which approaches the display unit 1. The proximity sensor 2 may be configured to output a signal generated by detecting the object approaching the display unit 1 to the controller 3 in real time to allow the controller 3 to recognize the signal.

The controller 3 may be configured to convert a screen between the various AVN modes (e.g., a home mode, a navigation mode, a radio mode, a multimedia mode, a DMB mode, or a phone mode) which may be operated in an AVN system based on the signals (e.g., information) transmitted from the proximity sensor 2 and the display unit 1. The controller 3 may be configured to display a home widget on the display unit 1 upon the determination based on the signal (information) transmitted from the proximity sensor 2 and display any one of the selected AVN modes by distinguishing input signals based on the signal (information) transmitted from the display unit 1 on the screen of the display unit 1.

In other words, the controller 3 may be configured to determine whether the object is approaching the display unit 1 based on the signal from the proximity sensor 2 and in response to determining that the object is proximate to the display unit 1, the controller 3 may be configured to display the home widget on the screen of the display unit 1 and distinguish the selected AVN mode based on a signal (gesture) of the user or object input on the display unit 1 to display the AVN mode on the screen of the display unit 1. DMB (Digital Multimedia Broadcasting) is a mobile TV service.

Particularly, the controller 3 may be an AVN controller configured to operate a plurality of devices (e.g., an audio, a video, and a navigation system) which may be driven in the AVN system. The controller 3 may be configured to distinguish the selected AVN mode based on a predetermined gesture input to the display unit 1 to display the AVN mode on the screen of the display unit 1. For example, the controller 3 may be configured to distinguish the selected AVN mode based on a drag direction of the predetermined gesture input onto the screen of the display unit 1 in a status where an arbitrary AVN mode is displayed on the screen of the display unit 1 and display the AVN mode based on the distinguished result on the screen of the display unit 1.

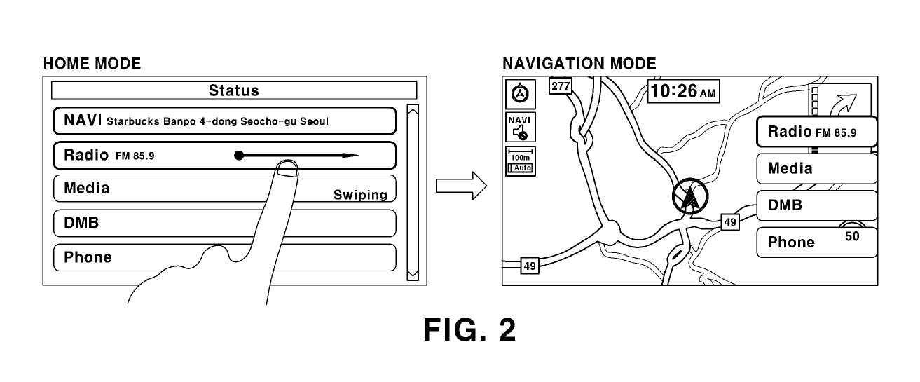

For example, referring to FIG. 2, when the user inputs a gesture which drags and moves the finger from the left to the right while contacting the finger onto the screen of the display unit 1, that is, when the user inputs a flicking gesture which drags the finger from the left to the right on the screen of the display unit 1, the controller 3 may be configured to convert the home mode which is being displayed on the screen of the display unit 1 into the navigation mode to be displayed. The gesture may be a motion signal input by the user while contacting the touch unit onto the screen of the display unit 1 and the flicking may be a motion which contacts the finger onto the screen and drags and moves the finger in one direction. The drag direction of the gesture input onto the display unit 1 in an arbitrary AVN mode may be set in advance to be stored in the controller 3 and when the controller 3 recognizes that the flicking gesture of the set drag direction is input to the display unit 2, the controller 3 may be configured to display the AVN mode that corresponds to the input gesture on the display unit 1.

For example, the drag direction of the gesture may be a direction from the left to the right, a direction from the right to the left, a direction from a top to a bottom, a direction from the bottom to the top, a direction from an upper left side to a lower right side, a direction from the lower right side to the upper left side, from the upper right side to the lower left side, and a direction from a lower left side to an upper right side. Therefore, different AVN modes may be stored in the controller to match (e.g., correspond to) the individual drag directions so that when a gesture which drags the finger in one direction on the screen of the display unit 1 is input, the screen may be converted to an AVN mode that corresponds to the gesture.

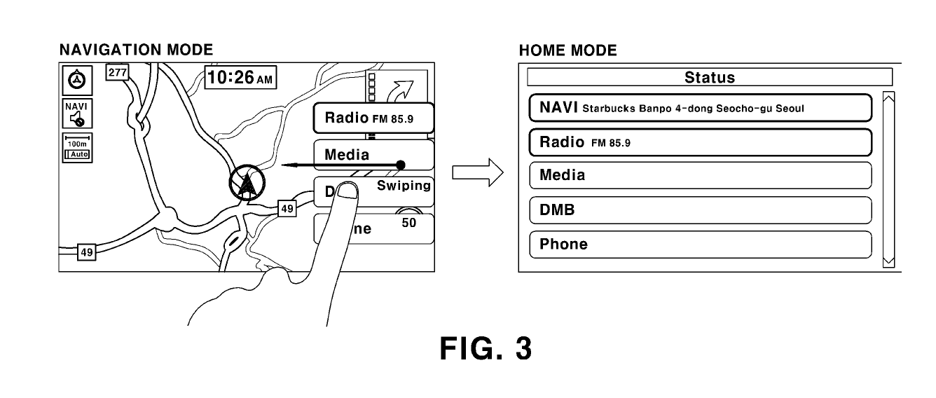

Specifically, when the flicking gesture which drags the finger in a predetermined direction is input to the display unit 1 in various AVN modes other than the home mode, the controller 3 may be configured to convert the AVN mode currently displayed on the display unit 1 into the home mode. For example, referring to FIG. 3, in the navigation mode, when a flicking gesture which drags the finger from the right to the left onto the screen of the display unit 1 is input, the controller 3 may be configured to convert the screen in the navigation mode currently displayed on the display unit 1 into the home mode. Therefore, it may be possible to enter a main AVN mode (or various AVN modes) through the flicking gesture input by the user by dragging the finger in a predetermined direction in the home mode and various AVN modes and it may be possible to return to or enter the home mode from various AVN modes. That is, it may be possible to enter the various AVN modes or simply return to the home mode by the flicking gesture in the predetermined direction input on the display unit 1 in the arbitrary AVN mode.

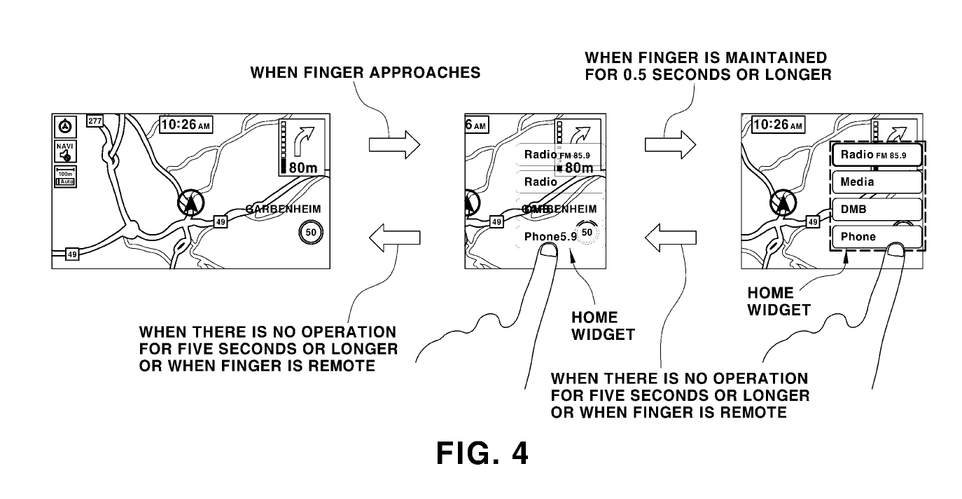

Referring to FIG. 4, when the object (e.g., finger, pen, etc.) approaches the display unit 1 within a predetermined distance in the various AVN modes, the controller 3 may be configured to display the home widget onto the display unit 1 to be popped up (e.g., may be configured to display the home widget in response to the object approach), so that conditions of other AVN modes may be checked in the currently displayed AVN mode. In particular, the controller 3 may be configured to determine whether the object approaches based on the signal of the proximity sensor 2 and detect an operation or non-operational status of the object based on the signal of the proximity sensor 2.

Therefore, the controller 3 may be configured to recognize approach and remoteness of the object (e.g., a touch unit) based on the information transmitted by the proximity sensor 2 and to recognize the movement (e.g., motion) and non-movement (e.g., non-motion) of the object. Further, when the controller 3 remains in a status where the controller is proximate to the display unit 1 within a predetermined distance for a predetermined time or greater in the various AVN modes, the controller 3 may be configured to display the home widget on the display unit 1 to be driven to more easily convert the screen from the AVN mode which is currently displayed into another AVN mode.

When the user touches and selects (e.g., pressure is applying by a user or an object onto the display screen) any one mode block M among the menus of the home widget, the controller 3 may be configured to convert the screen of the display unit 1 to the AVN mode that corresponds to the selected mode block. In other words, when the home widget is displayed on the screen of the display unit 1 to be driven or operate, when the user touches and selects any one mode block among the mode blocks M which configures the menus of the home widget, the controller 3 may be configured to display the AVN mode on the screen of the display unit 1. In particular, pressure may be exerted onto the screen of the display unit 1 on any one mode block M selected from the menus of the home widget and the controller 3 may be configured to convert the AVN mode screen currently displayed into a predetermined AVN mode screen that corresponds to the selected mode block.

The controller 3 may be configured to distinguish and recognize the AVN mode that corresponds to the selected mode block selected based on the information (e.g., a signal) transmitted from the display unit 1 to control mode conversion using the home widget. Particularly, the menu of the home widget may be configured by a plurality of mode blocks M that indicates different AVN modes and each mode block M may indicate a predetermined AVN mode and information regarding an operation of the AVN mode. In addition, when the controller 3 recognizes that the object is remote from the display unit 1 by a predetermined distance or greater or the object is not operated for a predetermined time or greater, the controller 3 may be configured to display the home widget which is displayed on the display unit 1 to be inoperable or remove the home widget from the screen of the display unit 1.

Referring to FIG. 4, when the object is remote from the display unit 1 by the predetermined distance or greater and the home widget is displayed on the display unit to be operable, the controller 3 may be configured to display the home widget to determine only the mode condition in the inoperable status. Further, for example, when the home widget is displayed on the display unit 1 to determine only the mode situation in the inoperable status, when the object is remote from the display unit 1 by the predetermined distance or greater, the controller 3 may be configured to remove the home widget from the display unit 1.

Further, for example, when the object (e.g., the touch unit) is not operated for a predetermined time or greater while the home widget is displayed on the display unit 1 to be operable, the controller 3 may be configured to display the home widget to observe or determine only the mode condition in the inoperable status. Additionally, for example, when the home widget is displayed on the display unit 1 to determine only the mode situation in the inoperable status, when the touch unit of the user is not operated in the display unit 1 for the predetermined time or greater, the controller 3 may be configured to remove the home widget from the display unit 1.

As described above, the AVN mode converting system according to the exemplary embodiment of the present invention may provide a user interface which may convert the screen between the AVN modes by operating the screen of the controller 3 using the signals of a display unit 1 and a proximity sensor 2 and may more easily determine the operation of the various AVNs including an operating AVN.

The invention has been described in detail with reference to exemplary embodiments thereof. However, it will be appreciated by those skilled in the art that changes may be made in these exemplary embodiments without departing from the principles and spirit of the invention, the scope of which is defined in the accompanying claims and their equivalents.

What is claimed is:

1. An audio-video-navigation (AVN) mode converting system, comprising:
a memory configured to store program instructions; and
a processor configured to execute the program instructions, the program instructions when executed configured to:
operate display unit configured to display an AVN mode being operated and detect an input signal through a touch unit;
detect an approach of the touch unit toward the display unit using a proximity sensor; and
display a home widget on the display unit based on information from the proximity sensor and distinguish the selected AVN mode based on the input signal to display the AVN mode on the display unit.

2. The system of claim 1, wherein the program instructions when executed are further configured to distinguish the selected AVN mode based on a predetermined gesture input to the display unit to display the AVN mode on the display unit.

3. The system of claim 1, wherein the program instructions when executed are further configured to distinguish the selected AVN mode based on a drag direction of a flicking gesture input to the display unit to display the AVN mode on the display unit.

4. The system of claim 1, wherein when a flicking gesture which drags a finger or an object in a predetermined direction is input to the display unit while displaying AVN modes other than a home mode on the display unit, the program instructions when executed are further configured to convert the screen of the display unit into the home mode.

5. The system of claim 1, wherein when the approach of the touch unit is within a predetermined distance, the program instructions when executed are further configured to display the home widget on the display unit to be inoperable to detect only a mode situation.

6. The system of claim 1, wherein when the approach of the touch unit maintains a proximate status to the display unit for a predetermined time or greater within a predetermined distance, the program instructions when executed are further configured to display the home widget on the display unit to be operable.

7. The system of claim 1, wherein when the touch unit is remote from the display unit by a predetermined distance or greater while the home widget is displayed on the display unit to be operable, the program instructions when executed are further configured to display the home widget to be inoperable to detect only a mode situation.

8. The system of claim 1, wherein when the touch unit is remote from the display unit by a predetermined distance or greater while the home widget is displayed on the display unit to be inoperable to detect only a mode situation, the program instructions when executed are further configured to remove the home widget from the display unit.

9. The system of claim 1, wherein when the touch unit is not operated on the display unit for a predetermined time or greater while the home widget is displayed on the display unit to be operable, the program instructions when executed are further configured to display the home widget to be inoperable to detect only a mode situation.

10. The system of claim 1, wherein when the touch unit is not operated on the display unit for a predetermined time or greater while the home widget is displayed on the display unit to be inoperable to detect only a mode situation, the program instructions when executed are further configured to remove the home widget from the display unit.

11. The system of claim 6, wherein when any one mode block among menus of the home widget is touched and selected, the program instructions when executed are further configured to convert the screen of the display unit into an AVN mode that corresponds to the selected mode block.

12. The system of claim 11, wherein the menu of the home widget is configured by a plurality of mode blocks which indicates different AVN modes and each mode block displays information regarding an operate of the AVN mode.

13. An audio-video-navigation (AVN) mode converting method, comprising:
distinguishing, by a controller, a selected AVN mode based on a predetermined gesture input on a display unit configured to display any one of a plurality of operating AVN modes; and
displaying, by the controller, the distinguished AVN mode on the display unit.

14. The method of claim 13, further comprising:
displaying, by the controller, a home widget on the display unit based on a detection result of a touch unit which approaches the display unit.

15. The method of claim 13, further comprising:
distinguishing, by the controller, the selected AVN mode based on a predetermined gesture input to the display unit to display the AVN mode on the display unit.

16. The method of claim 13, wherein distinguishing the selected AVN mode is based on a drag direction of a flicking gesture input to the display unit to display the AVN mode on the display unit.

17. The method of claim 13, further comprising:
converting, by the controller, the screen of the display unit into the home mode when a flicking gesture which drags a finger in a predetermined direction is input to the display unit while displaying AVN modes other than a home mode on the display unit.

18. The method of claim 14, further comprising:
displaying, by the controller, the home widget on the display unit to be inoperable to detect only a mode situation when a touch unit approaches the display unit within a predetermined distance.

19. The method of claim 14, further comprising:
displaying, by the controller, the home widget on the display unit to be operable when the touch unit maintains a proximate status to the display unit for a predetermined time or greater within a predetermined distance.

20. The method of claim 14, further comprising:
displaying, by the controller, the home widget to be inoperable to detect only a mode situation when the touch unit is remote from the display unit by a predetermined distance or greater while the home widget is displayed on the display unit to be operable.

21. The method of claim 14, further comprising:
removing, by the controller, the home widget from the display unit when the touch unit is remote from the display unit by a predetermined distance or greater while the home widget is displayed on the display unit to be inoperable to detect only a mode situation.

22. The method of claim 14, further comprising:
displaying, by the controller, the home widget to be inoperable to detect only a mode situation when the touch unit is not operated on the display unit for a predetermined time or greater while the home widget is displayed on the display unit to be operable.

23. The method of claim 14, further comprising:
removing, by the controller, the home widget from the display unit when the touch unit is not operated on the display unit for a predetermined time or greater while the home widget is displayed on the display unit to be inoperable to detect only a mode situation.

24. The method of claim 23, further comprising:
converting, by the controller, the screen of the display unit into an AVN mode that corresponds to the selected mode block in response to a selection of a mode block among menus of the home widget.

25. A non-transitory computer readable medium containing program instructions executed by a controller, the computer readable medium comprising:
program instructions that distinguish a selected AVN mode based on a predetermined gesture input on a display unit configured to display any one of a plurality of operating AVN modes; and
program instructions that display the distinguished AVN mode on the display unit.
